(19) United States
(12) Patent Application Publication
(10) Pub. No.: US 2018/0311794 A1
(43) Pub. Date: Nov. 1, 2018

(54) Hand Grip Clamp

(71) Applicant: Delaware Capital Formation, Inc., Wilmington, DE (US)

(72) Inventor: Thomas M. Grobbel, Ortonville, MI (US)

(21) Appl. No.: 15/933,454

(22) Filed: Mar. 23, 2018

Related U.S. Application Data
(60) Provisional application No. 62/490,691, filed on Apr. 27, 2017.

(51) Int. Cl. B25B 5/04

(52) U.S. Cl. CPC B25B 5/04; B25B 7/04

(57) ABSTRACT

A hand clamp has a body with a grip portion to receive a user's hand. A first jaw extends away from the grip portion. A second jaw is pivotally coupled with the body. The second jaw pivots with respect to the body to align with the first jaw to clamp a workpiece. A handle is coupled with the body and the second jaw. The handle is movable between a first and a second position. In the first position, the first and second jaws are clamped onto the workpiece. In the second position, the second jaw rotates away from the workpiece to enable the hand grip clamp to be removed from the workpiece.

### CROSS-REFERENCE TO RELATED APPLICATION

This application claims the benefit of U.S. Provisional Application No. 62/490,691, filed on Apr. 27, 2017. The entire disclosure of the above application is incorporated herein by reference.

### FIELD

The present disclosure relates to hand grip clamp and, more particularly, to a hand grip clamp that reduces overall length of the clamp.

### BACKGROUND

Traditional plier clamps do not provide an ergonomically useable handle. These traditional plier clamps include handles that extend a substantial distant from the workpiece. Thus, this increases the mechanical moment on the workpiece while also increasing the chance that the handle may interfere with or bump as passersby walk by the workpiece.

Accordingly, it is desirable to provide a hand grip clamp that overcomes the disadvantages of traditional plier clamps. The present disclosure provides an ergonomically designed hand grip clamp. The present disclosure provides a hand grip with a desired curved configuration that does not extend substantially beyond the workpiece. This reduces the mechanical moment on the workpiece as well as reducing the extending overhang. Additionally, this reduces the opportunity of the clamp to be bumped or the like by a passerby. The curvature configuration eliminates a sharp or poke point that currently exists in traditional plier clamps. Also, the present disclosure provides a face that abuts against the workpiece to enable additional force to be applied on the workpiece.

### SUMMARY

According to the present disclosure, a hand clamp comprises a body with a grip portion to receive a user's hand. A first jaw extends from the body away from the grip. A second jaw is pivotally coupled with the body. The second jaw pivots with respect to the body to align with the first jaw to clamp a workpiece. A handle is coupled with the body and the second jaw. The handle is movable between a first and a second position. In the first position, the first and second jaws are clamped on the workpiece. In the second position, the second jaw is not aligned with the first jaw and the hand clamp is able to be removed from the workpiece. The grip portion is substantially perpendicular to the first jaw. A link is coupled with the handle and the second jaw. The link nests against the body in the first or clamped position. At least one boss is on the body to couple the handle and the second jaw with the body. The second jaw has an overall crescent shape. A portion of the inner surface of the second jaw is adjacent the body in the clamped position so that it has a shape complementary to a surface of the body. The hand clamp has an overall U-shape in the clamped position. The body further comprises an inner surface to contact the workpiece.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a hand clamp in an open position.

FIG. 2 is a side elevation view of the hand clamp 1 attached to a workpiece.

FIG. 3 is a view like FIG. 2 with the clamp abutting the workpiece.

FIG. 4 is an exploded view of the hand clamp.

### DETAILED DESCRIPTION

Example embodiments will now be described more fully with reference to the accompanying drawings.

Turning to the figures, a hand grip clamp is illustrated and designated with the reference numeral 10. The hand grip clamp includes a body 12, a handle 14 and a movable jaw 16. The handle 14 and movable jaw 16 are pivotally coupled with the body 12.

The body 12 includes a grip portion 18 and a first jaw 20. The grip 18 includes an opening 22 to enable passage of a user's hand. Additionally, the grip portion includes a curved surface portion 24 with peaks 26 and valleys 28 that enable the user's fingers to seat on the grip portion 18.

The body 12 also includes a first boss 30 and a second boss 32. The bosses 30, 32 project from the grip portion 18. The bosses 30, 32 include apertures 34 to receive rivets 36. The rivets 36 pivotally secure the handle 14 and movable jaw 16 with the body 12.

The fixed or first jaw 20 projects from the grip portion 18. The fixed or first jaw 20 includes a barrel 40 at the free end of the fixed jaw 20. A spindle 38 is threadily received in a bore in the barrel 40. The fixed jaw 20 is substantially perpendicular to the grip portion 18 to provide an overall L shape to the body 12. The grip portion 18 includes a surface 42. The surface 42 is substantially planar. The planar surface 42 enables the body 12 to abut the workpiece 15 as illustrated in FIG. 3. This provides a surface face that contacts the workpiece 15. Accordingly, additional force can be applied by the operator, utilizing the operator's body weight, to ensure a greater clamping force, of the clamp, onto the workpiece.

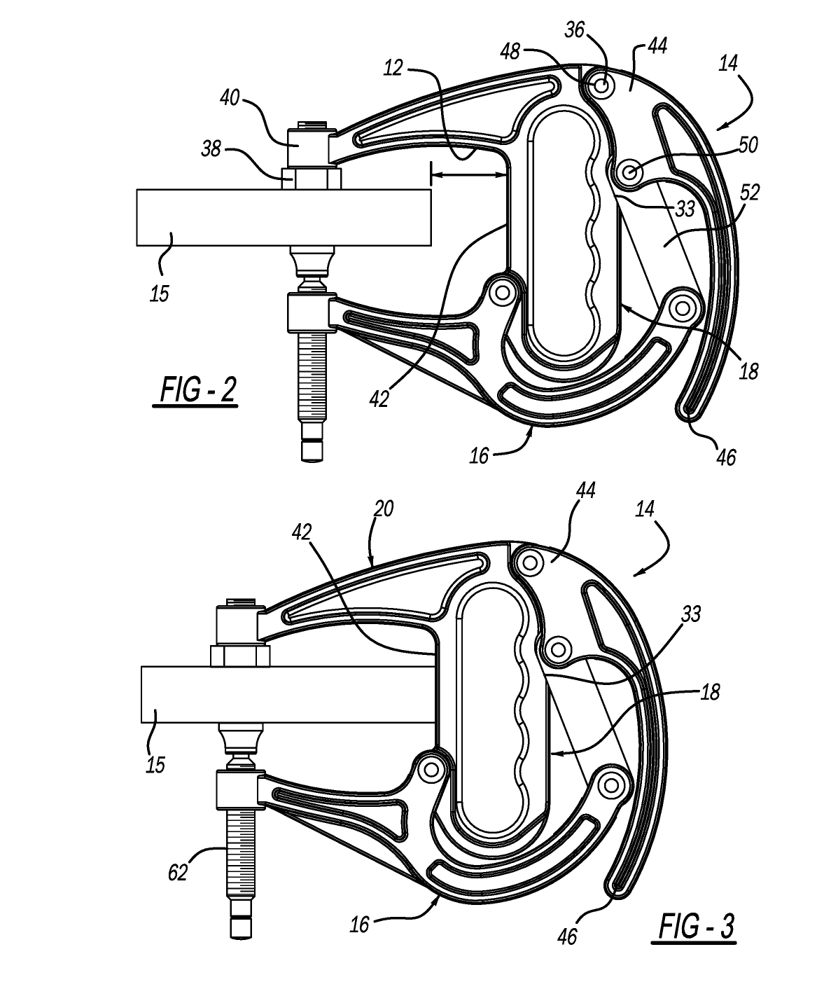

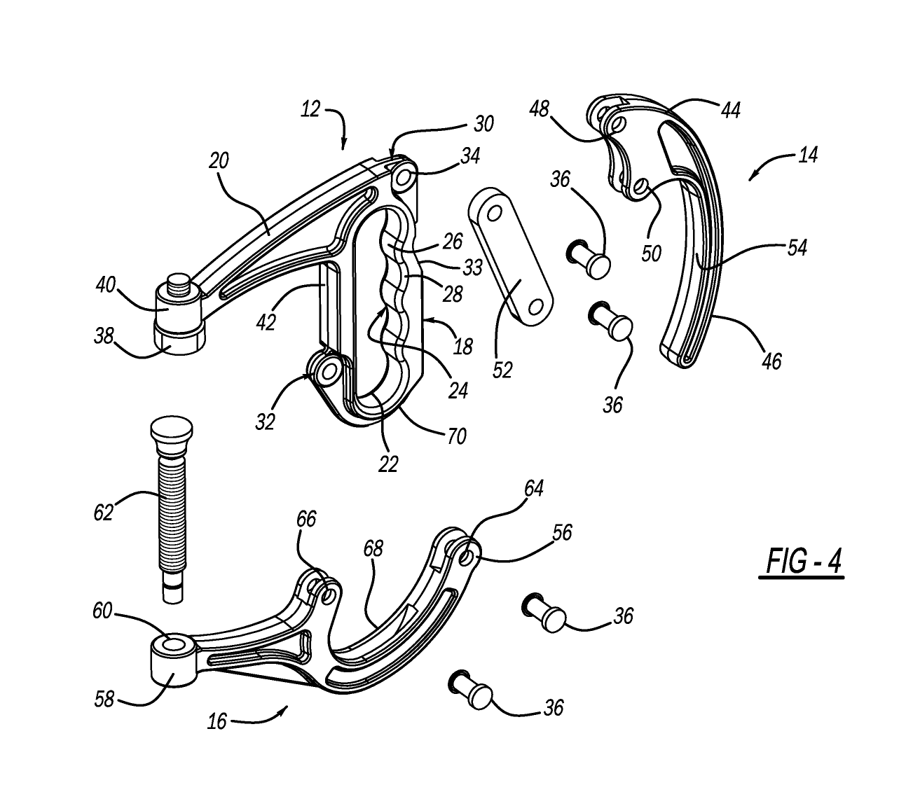

The handle 14 has an arcuate configuration with a head portion 44 and a tail portion 46. The head portion 44 includes a pair of apertures 48, 50 that receive rivets 36 to secure with the boss 30 and with a link 52. The link 52 is also pivotally coupled, via a rivet 36, to the movable jaw 16. The link 52 nests against the handle portion 33 when the handle 14 is in a closed position as illustrated in FIGS. 2 and 3. The handle 14 includes an inner surface 54 that is adjacent the head 56 of the movable jaw 16 when the hand grip clamp 10 is in a clamped position as illustrated in FIGS. 2 and 3.

The movable jaw 16 has an overall crescent shape with a head 56 and a barrel 58. The barrel 58 includes a threaded aperture 60 to receive an adjustable clamp spindle 62. The head 56 includes a pair of aperture 64. The aperture 64 receives rivet 36 to secure the link 52 with the movable jaw 16. Additionally, aperture 66, between the head 56 and barrel 58, receives rivet 36 to pivotally secure the movable jaw 16 with the boss 32. The movable jaw 16 includes a curved inner surface 68. The curved inner surface 68 has a complimentary shape to the body curve surface 70. Thus, when in the closed position, as illustrated in FIGS. 2 and 3, the movable jaw 16 is adjacent the body curve surface 70 providing a compact configuration.

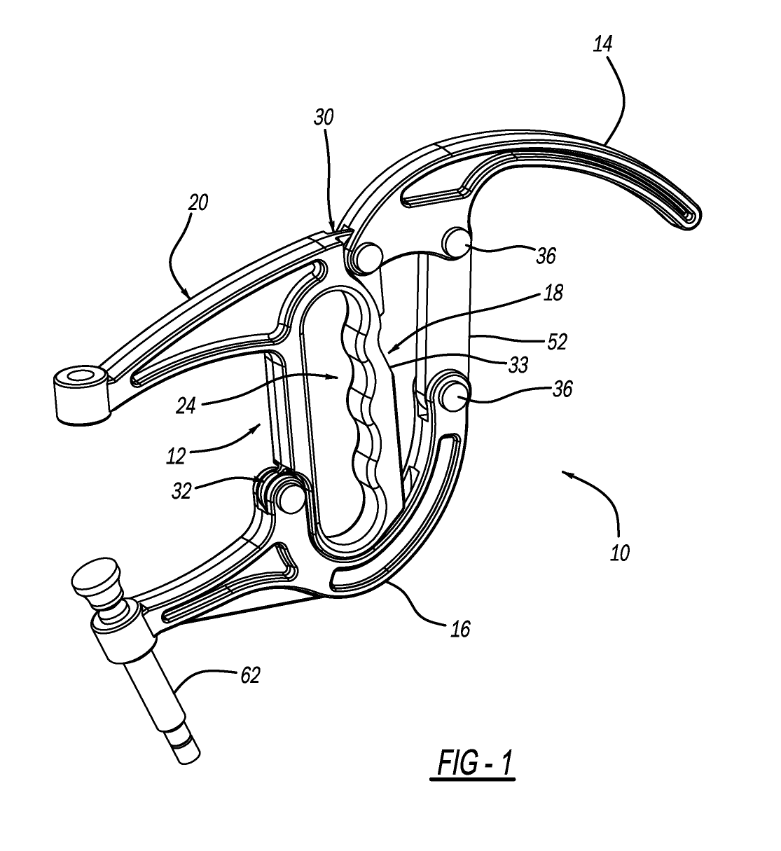

The hand grip clamp 10 functions as follows. In the open position, illustrated in FIG. 1, the handle tail 46 is positioned away from the body 12. The fixed or first jaw 20 is positioned onto a workpiece 15. The handle 14 is then pushed, with a force, toward the body 12. As this occurs, the link 52 is moved so that it moves the movable jaw 16. The movable jaw 16 rotates about the rivet 36 secured with the boss 32. As this occurs, the adjustable spindle 62 contacts the workpiece 15. At this time, if only a hand squeezing force is to be applied as in FIG. 2, the handle 14 is in its closed position as illustrated in FIG. 2. The handle 14 and link 52 provides an over center locking of the handle 14 on the body 12. If a larger force is needed on the workpiece 15, the body surface 42 is positioned against the workpiece 15. Now, the user can utilize his body weight to assist in pushing the handle 14 towards the body 12. This adds an additional clamping force onto the workpiece 15 by the hand grip clamp as illustrated in FIG. 3.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A hand grip clamp comprising:
a body with a grip portion to receive a user's hand;
a first jaw extends away from the grip portion;
a second jaw is pivotally coupled with the body, the second jaw is pivotal with respect to the body to align with the first jaw to clamp a workpiece; and
a handle is coupled with the body and the second jaw, the handle is movable between a first and a second position, in the first position, the first and second jaws are clamped onto the workpiece and in the second position, the second jaw is rotated away from the workpiece and the hand grip clamp is able to be removed from the workpiece.

2. The hand grip clamp of claim 1, wherein the grip portion is substantially perpendicular to the first jaw.

3. The hand grip clamp of claim 1, further comprising a link coupled with the handle and the second jaw.

4. The hand grip clamp of claim 3, wherein the link nest against the body in a clamped position.

5. The hand grip clamp of claim 1, further comprising at least one boss for coupling the handle and the second jaw with the body.

6. The hand grip clamp of claim 1, wherein the second jaw has an overall crescent shape.

7. The hand grip clamp of claim 6, wherein a portion of an inner surface of the second jaw is adjacent the body in the clamped position so that it has a shape complimentary to the body.

8. The hand grip clamp of claim 1, wherein the hand clamp has an overall U-shape in the clamped position.

9. The hand grip clamp of claim 1, wherein the body further comprises a surface for contacting the workpiece.
